(19) United States
(12) Patent Application Publication
(10) Pub. No.: US 2023/0150358 A1
(43) Pub. Date: May 18, 2023

(54) COLLISION AVOIDANCE SYSTEM AND METHOD FOR AVOIDING COLLISION OF WORK MACHINE WITH OBSTACLES

(71) Applicant: Caterpillar Inc., Peoria, IL (US)

(72) Inventors: Jacob Maley, Germantown Hills, IL (US); Chen Sun, Dunlap, IL (US); Jun Zuo, Peoria, IL (US); Venkata Siva Sai Manoj Pothugunti, Peoria, IL (US)

(73) Assignee: Caterpillar Inc., Peoria, IL (US)

(21) Appl. No.: 17/455,654

(22) Filed: Nov. 18, 2021

(51) Int. Cl. B60K 31/00; B60R 1/00; B60Q 9/00; E02F 9/26; E02F 9/20; H04N 5/268; H04N 5/247; H04N 7/18

(52) U.S. Cl. CPC B60K 31/0008; B60R 1/00; B60Q 9/008; E02F 9/261; E02F 9/2025; E02F 9/2062; E02F 9/2083; H04N 5/268; H04N 5/247; H04N 7/181; B60K 2031/0025; B60R 2300/8093; B60R 2300/105

(57) ABSTRACT

A collision avoidance system for a work machine includes at least one sensor configured to generate a signal indicative of a presence of at least one obstacle in a surrounding area of the work machine, at least one imaging device, a display device, and a controller. The controller receives the signal indicative of the presence of the obstacle and determines a position of the obstacle relative to the work machine based on the signal received from the sensor. The controller generates a first control signal to prevent a movement of the work machine, halt the movement of the work machine, or reduce a velocity of the work machine based on the determination of the position of the obstacle. The controller generates a second control signal for displaying an updated display view that provides a visual indication of the presence of the obstacle in the surrounding area of the work machine.

### TECHNICAL FIELD

The present disclosure relates to a collision avoidance system and a method for avoiding collision of a work machine with one or more obstacles.

### BACKGROUND

Work machines, such as, excavators, motor graders, loaders, and the like may be used at various construction worksites to perform operations, such as, material removal, transportation, and the like. Such work machines typically operate in highly interactive environments with ground crew moving around the work machine, varying road surfaces being cut and repaired, and barriers and obstacles that need to be navigated by the work machine. It may be challenging for an operator to be aware of such dynamic environments and accordingly navigate the work machine. More particularly, a visibility of the operator may be obstructed by portions of the work machine itself or the obstacles present near the work machine.

In some examples, if the operator is unaware of the obstacles that may be present in a path of the work machine, there may be a possibility of a collision between the work machine and the obstacle, which may not be desired. In some examples, a collision prevention system may be used to control a movement of the work machine for preventing a movement of the work machine towards the obstacle for averting collision. However, due to limited visibility, the operator may not be aware of the obstacle that may be causing the collision prevention system to control the movement of the work machine. Therefore, it may be desirable to have a means for notifying the machine operator regarding the obstacles that may be causing the collision prevention system to control the movement of the work machine.

U.S. Publication Application Number 2012/0287277 describes a display system for a mobile machine operating at a worksite. The display system may have at least one detection device configured to detect objects within a distance of the mobile machine, at least one camera configured to generate a plurality of camera views of the worksite around the mobile machine, a display located within the mobile machine, and a controller in communication with the at least one detection device, the at least one camera, and the display. The controller may be configured to cause an indication of proximity of objects detected by the at least one detection device to be shown on the display, and to automatically cause the camera view of the plurality of camera views associated with a closest objected detected by the at least one detection device to be shown on the display simultaneous with the indication of proximity.

### SUMMARY OF THE DISCLOSURE

In one aspect of the present disclosure, a collision avoidance system for a work machine is provided. The collision avoidance system includes at least one sensor configured to generate a signal indicative of a presence of at least one obstacle in a surrounding area of the work machine. The collision avoidance system also includes at least one imaging device associated with the work machine. The imaging device is configured to capture a visual feed of the surrounding area of the work machine. The collision avoidance system further includes a display device associated with the work machine. The collision avoidance system includes a controller communicably coupled with the sensor, the imaging device, and the display device. The controller is configured to receive the signal indicative of the presence of the obstacle in the surrounding area of the work machine from the sensor. The controller is also configured to determine a position of the obstacle relative to the work machine based on the signal received from the sensor. The controller is further configured to generate a first control signal to at least one of prevent a movement of the work machine, halt the movement of the work machine, and reduce a velocity of the work machine based on the determination of the position of the obstacle. The controller is configured to generate a second control signal for displaying an updated display view based on the determination of the position of the obstacle. The updated display view provides a visual indication of the presence of the obstacle in the surrounding area of the work machine.

In another aspect of the present disclosure, a method for avoiding collision of a work machine with at least one obstacle is provided. The method includes generating, by at least one sensor, a signal indicative of a presence of the at least one obstacle in a surrounding area of the work machine. The method also includes capturing, by at least one imaging device associated with the work machine, a visual feed of the surrounding area of the work machine. The method further includes receiving, by a controller, the signal indicative of the presence of the obstacle in the surrounding area of the work machine from the sensor. The controller is communicably coupled to the sensor, the imaging device, and a display device associated with the work machine. The method includes determining, by the controller, a position of the obstacle relative to the work machine based on the signal received from the sensor. The method also includes generating, by the controller, a first control signal to at least one of prevent a movement of the work machine, halt the movement of the work machine, and reduce a velocity of the work machine based on the determination of the position of the obstacle. The method further includes generating, by the controller, a second control signal for displaying an updated display view based on the determination of the position of the obstacle. The updated display view provides a visual indication of the presence of the obstacle in the surrounding area of the work machine.

In yet another aspect of the present disclosure, a work machine is provided. The work machine includes a frame. The work machine also includes a plurality of ground engaging members supported by the frame. The work machine further includes a collision avoidance system. The collision avoidance system includes at least one sensor configured to generate a signal indicative of a presence of at least one obstacle in a surrounding area of the work machine. The collision avoidance system also includes at least one imaging device associated with the work machine. The imaging device is configured to capture a visual feed of the surrounding area of the work machine. The collision avoidance system further includes a display device associated with the work machine. The collision avoidance system includes a controller communicably coupled with the sensor, the imaging device, and the display device. The controller is configured to receive the signal indicative of the presence of the obstacle in the surrounding area of the work machine from the sensor. The controller is also configured to determine a position of the obstacle relative to the work machine based on the signal received from the sensor. The controller is further configured to generate a first control signal to at least one of prevent a movement of the work machine, halt the movement of the work machine, and reduce a velocity of the work machine based on the determination of the position of the obstacle. The controller is configured to generate a second control signal for displaying an updated display view based on the determination of the position of the obstacle. The updated display view provides a visual indication of the presence of the obstacle in the surrounding area of the work machine.

Other features and aspects of this disclosure will be apparent from the following description and the accompanying drawings.

### BRIEF DESCRIPTION OF THE DRAWINGS

FIG. 1 illustrates a side view of a work machine and an obstacle present around the work machine, according to examples of the present disclosure;

FIG. 2 illustrates a block diagram of a collision avoidance system associated with the work machine of FIG. 1, according to examples of the present disclosure;

FIG. 3 illustrates an updated display view generated on a display device associated with the collision avoidance system of FIG. 2, according to one example of the present disclosure;

FIG. 4 illustrates an updated display view generated on the display device associated with the collision avoidance system of FIG. 2, according to another example of the present disclosure; and

FIG. 5 illustrates a flowchart for a method for avoiding collision of the work machine with one or more obstacles, according to examples of the present disclosure.

### DETAILED DESCRIPTION

Wherever possible, the same reference numbers will be used throughout the drawings to refer to the same or like parts. Wherever possible, corresponding or similar reference numbers will be used throughout the drawings to refer to the same or corresponding parts.

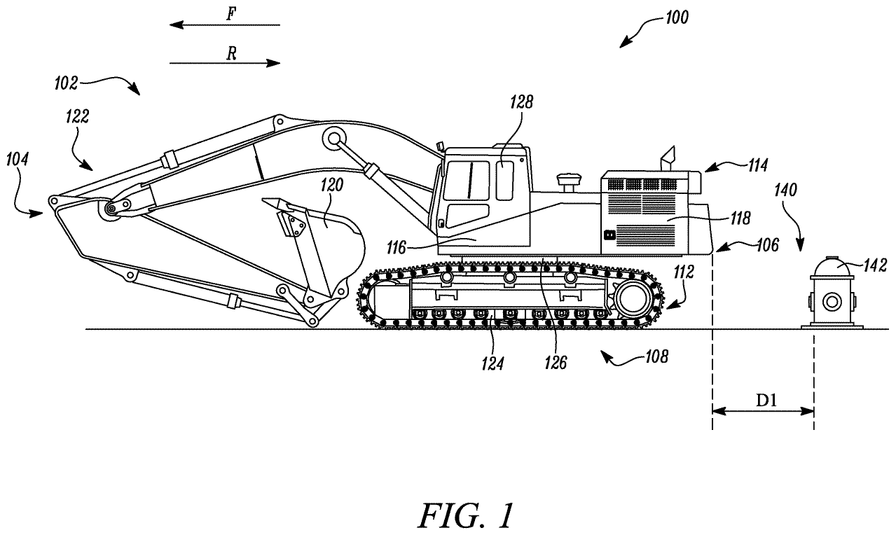

FIG. 1 illustrates an exemplary work machine 100 operating at a worksite 102. The work machine 100 is embodied as a hydraulic excavator herein. Accordingly, the work machine 100 may perform one or more excavation operations at the worksite 102. Although shown as the hydraulic excavator, it may be understood that the work machine 100 may alternatively include other work machines, such as, motor graders, loaders, mining shovels, dozers, tractors, or compactors, without any limitations. Further, the work machine 100 may include a manual machine, an autonomous machine, or a semi-autonomous machine.

The work machine 100 may move in a forward direction “F” or a reverse direction “R”. The work machine 100 defines a front end 104 and a rear end 106. Further, the work machine 100 defines a first side 108 embodied as a left side of the work machine 100 in relation to the movement of the work machine 100 in the forward direction “F”. Moreover, the work machine 100 defines a second side (not shown) opposite to the first side 108 and embodied as a right side of the work machine 100 in relation to the movement of the work machine 100 in the forward direction “F”.

The work machine 100 includes a lower structure 112 and an upper structure 114 movably coupled with the lower structure 112. The work machine 100 includes a frame 116. Specifically, the upper structure 114 includes the frame 116. The upper structure 114 may support various components of the work machine 100 thereon. The upper structure 114 defines an enclosure 118. The enclosure 118 allows mounting of a power source (not shown). The power source may provide operating power to the work machine 100 for mobility and operational requirements. The power source may include, but is not limited to, a diesel engine, a gasoline engine, a gaseous fuel powered engine, a dual fuel powered engine, an electric motor, a fuel cell, a battery, and/or a combination thereof, based on application requirements. Additionally, the work machine 100 may include components (not shown) and/or systems (not shown), such as a braking system, a fuel delivery system, an air delivery system, an exhaust system, a drivetrain, a hydraulic system, a transmission system, and so on, based on application requirements.

The work machine 100 may also include a work implement 120 disposed proximate to the front end 104. The work implement 120 may be operably connected to the upper structure 114 by a linkage assembly 122. The work implement 120 may be used for various material handling operations, material removal operations, and/or material transportation operations. For example, during an excavation operation, the work implement 120 may contact ground surfaces for removing material therefrom.

Further, the work machine 100 includes a number of ground engaging members 124 supported by the frame 116. The ground engaging members 124 may provide support and mobility to the work machine 100 on ground surfaces. As such, the ground engaging members 124 may enable travel/tramming of the work machine 100 on ground surfaces. The work machine 100 includes two ground engaging members 124 (only one ground engaging member 124 is shown in the accompanying figure) disposed at each of the first side 108 and the second side of the work machine 100. In the illustrated example of FIG. 1, the ground engaging members 124 are embodied as tracks. In other examples, the ground engaging members 124 may embody wheels or drums.

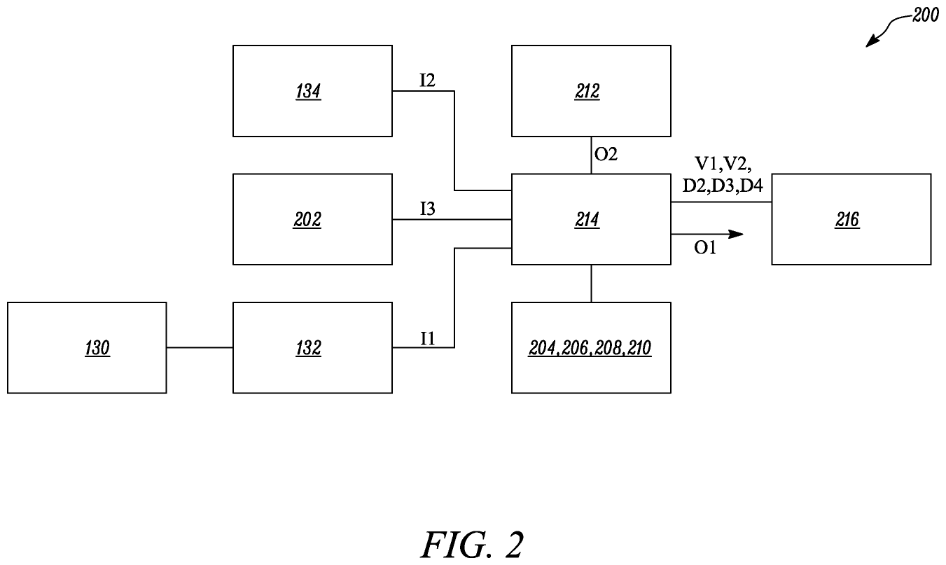

The work machine 100 includes a turn table 126. The turn table 126 may be mounted on the lower structure 112, upon which the upper structure 114, including an operator cabin 128, may be pivotally mounted. The operator cabin 128 may be supported by the frame 116. The operator cabin 128 may move relative to the lower structure 112. Further, the operator cabin 128 may include one or more input devices 130 (shown in FIG. 2). The input devices 130 may include a lever, a pedal, a button, a knob, a joystick, and the like. In some examples, the input devices 130 may include a first sensor 132 associated therewith. Further, the first sensor 132 may include a single sensor or a combination of sensors. The first sensor 132 may embody a position sensor that may generate a signal “I1” indicative of a position of a corresponding input device 130. For example, if the input device 130 is being used to effectuate a movement of the linkage assembly 122 or the work implement 120 towards the first side 108 or the second side of the work machine 100, the signal “I1” from the first sensor 132 may indicate if the linkage assembly 122 or the work implement 120 is moving towards or is disposed at the first side 108 or the second side of the work machine 100. In another example, if the input device 130 is being used to effectuate a movement of the ground engaging members 124, the signal “I1” from the first sensor 132 may indicate if the ground engaging members 124 are moving in the forward direction “F” or the reverse direction “R”. In some examples, the input device 130 may be present at a base station (not shown) which may be located remotely with respect to the work machine 100. For example, the input device 130 may be disposed at the base station that may be located offsite.

Further, the work machine 100 may include a second sensor 134 (shown in FIG. 2) that generates signals “I2” indicative of a direction of movement of one or more movable components of the work machine 100. Further, the second sensor 134 may include a single sensor or a combination of sensors. The second sensor 134 may include an inertial measurement unit (IMU). The IMU may be mounted at any location on the linkage assembly 122, the work implement 120, the upper structure 114, the lower structure 112, and the like. In an example, the second sensor 134 may include a gyroscopic device. In some examples, the second sensor 134 may include a swing angle sensor.

Further, the second sensor 134 may be mounted on the linkage assembly 122 or the work implement 120, such that the second sensor 134 may generate the signals “I2” indicative of the swing movement of the linkage assembly 122 or the work implement 120. Furthermore, the second sensor 134 may be mounted on the ground engaging members 124, such that the second sensor 134 may generate the signals “I2” indicative of the direction of the movement of the ground engaging members 124. In some examples, the second sensor 134 may be mounted on the turn table 126, such that the second sensor 134 may generate the signals “I2” indicative of the movement of the upper structure 114 relative to the lower structure 112. It should be noted that a type of the second sensor 134 mentioned herein does not limit the scope of the present disclosure and the work machine 100 may include any other type of sensor that may provide the desired features.

As shown in FIG. 2, the present disclosure relates to a collision avoidance system 200 for the work machine 100 (see FIG. 1). The collision avoidance system 200 includes one or more sensors 202 to generate a signal “I3” indicative of a presence of one or more obstacles 142, 302, 402 (shown in FIGS. 1, 3, and 4, respectively) in a surrounding area 140 (shown in FIG. 1) of the work machine 100. The obstacles 142, 302, 402 may include an infrastructure, another work machine, a pile of material, a personnel, and the like. Although a single obstacle 142 embodied as a fire hydrant is illustrated in FIG. 1, it should be noted that the worksite 102 (see FIG. 1) may include multiple obstacles of different shapes and sizes present thereon. It should be further noted that, although the obstacles 142, 302, 402 are positioned on the ground surface herein, it may be contemplated that the worksite 102 may include overhead or hanging obstacles that may be either in a suspended form, such as, cranes, or may be movable obstacles, such as, drones, without any limitations.

Further, as shown in FIG. 2, the sensor 202 may include a single sensor or a combination of sensors. The sensor 202 may be mounted on the work machine 100. For example, the sensor 202 may be mounted on the upper structure 114 (see FIG. 1) of the work machine 100. In an example, the sensor 202 may be mounted on top of the operator cabin 128 (see FIG. 1) of the work machine 100. In some examples, the sensor 202 may include one or more of a perception sensor and a proximity sensor. In an example, the sensor 202 may embody an imaging device 204, 206, 208, 210. The imaging device 204, 206, 208, 210 may be used to sense the surrounding area 140 of the work machine 100. For example, the imaging device 204, 206, 208, 210 may capture images or videos of the surrounding area 140 of the work machine 100.

In other examples, the sensor 202 may embody a Light Detection and Ranging (LiDAR) sensor or a Radio Detection and Ranging (RADAR) sensor, without any limitations. In some examples, the sensor 202 may include a combination of the imaging device 204, 206, 208, 210, the LiDAR sensor, and the RADAR sensor. It should be noted that the present disclosure is not limited by a type of the sensor 202, and the sensor 202 may include any other type of sensor that provides the desired functionalities. In an example, the signals “I3” generated by the sensor 202 may be used to determine a distance “D1” (shown in FIG. 1) between the obstacle 142, 302, 402 and the work machine 100 or a bearing angle of the obstacle 142, 302, 402 from the work machine 100. For explanatory purposes, the distance “D1” is illustrated between the obstacle 142 and the rearmost portion of the work machine 100. However, the distance “D1” may be defined between the work machine 100 and a corresponding obstacle 302, 402 in a similar manner, without any limitations.

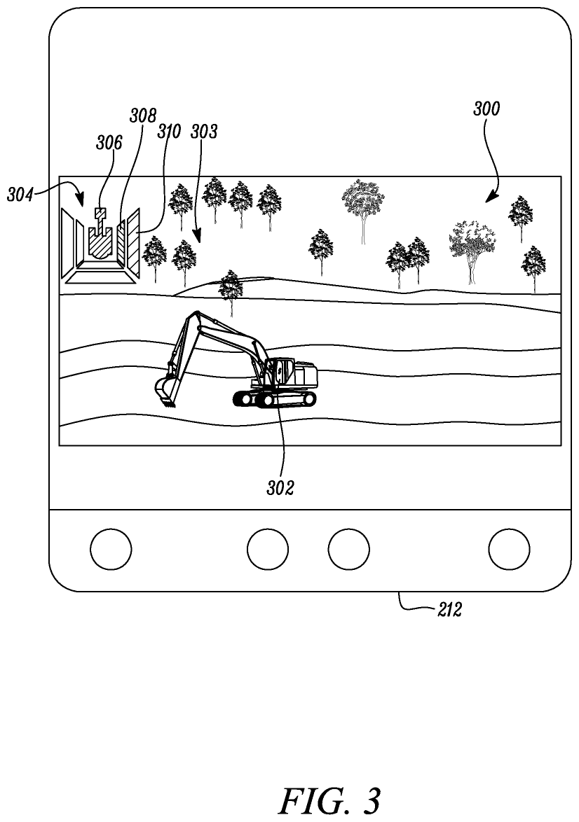

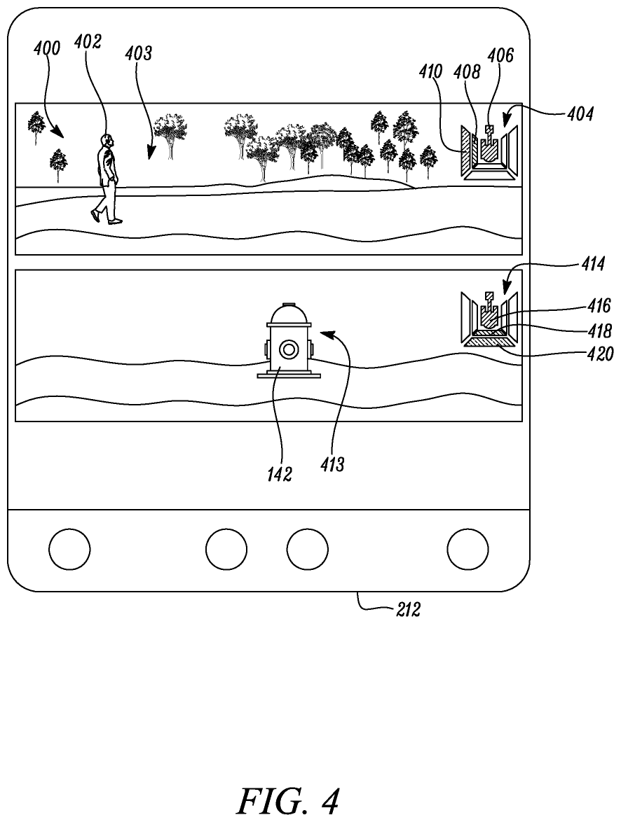

The collision avoidance system 200 includes the one or more imaging devices 204, 206, 208, 210 associated with the work machine 100. The imaging device 204, 206, 208, 210 captures a visual feed 303, 403, 413 (shown in FIGS. 3 and 4, respectively) of the surrounding area 140 of the work machine 100. It should be noted that, in some examples, the visual feed 303, 403, 413 may include images or videos. Alternatively, the visual feed 303, 403, 413 may include an occupancy map instead of the images or the videos. The occupancy map may embody a grid in which each cell of the grid may include an obstacle (such as, the obstacles 142, 302, 402) or a free space.

Further, the work machine 100 may include a single imaging device or multiple imaging devices mounted at different locations on the work machine 100. For example, the work machine 100 may include the single imaging device that may move to capture visuals of the surrounding area 140 of the work machine 100 In the illustrated example, the one or more imaging devices 204, 206, 208, 210 includes a number of imaging devices 204, 206, 208, 210 that capture the visual feed 303, 403, 413 of the surrounding area 140 of the work machine 100. Specifically, the collision avoidance system 200 includes four imaging devices 204, 206, 208, 210. For example, the collision avoidance system 200 includes the imaging device 204 that generates visuals of the surrounding area 140 proximate to the front end 104 (see FIG. 1) of the work machine 100. The collision avoidance system 200 includes the imaging device 206 that generates visuals of the surrounding area 140 proximate to the rear end 106 (see FIG. 1) of the work machine 100. The collision avoidance system 200 includes the imaging device 208 that generates visuals of the surrounding area 140 proximate to the first side 108 (see FIG. 1) of the work machine 100. The collision avoidance system 200 includes the imaging device 210 that generates visuals of the surrounding area 140 proximate to the second side of the work machine 100. It should be noted that the collision avoidance system 200 may include more than four imaging devices or less than four imaging devices, as per application requirements.

The imaging devices 204, 206, 208, 210 may embody a known in the art image capturing device mounted on the work machine 100, such as, a camera, a camcorder, a closed-circuit television (CCTV), and the like. In an example, the imaging devices 204, 206, 208, 210 may include a digital video camera, such as, an ethernet camera to provide an electronic motion picture acquisition. In some examples, the imaging device 204, 206, 208, 210 may embody monocular lens cameras or a combination of monocular lens cameras and stereo/triple lens cameras, without any limitations. The imaging devices 204, 206, 208, 210 may be mounted at any mounting location on the work machine 100, such as, the operator cabin 128, proximate to the enclosure 118 (see FIG. 1), and the like. It should be noted that the present disclosure is not limited by a type of the imaging device 204, 206, 208, 210 or the mounting location of the imaging device 204, 206, 208, 210.

The collision avoidance system 200 further includes a display device 212 associated with the work machine 100. In an example, the display device 212 may be disposed in the operator cabin 128. In another example, the display device 212 may be present at the base station located remotely with respect to the work machine 100. For example, the display device 212 may be disposed at the base station that may be located offsite. In some examples, the display device 212 may embody a touch screen device that may include means to provide outputs to the machine operator and may also include means to receive inputs, that may be physical inputs or virtual inputs, from the machine operator. The display device 212 embodied as the touch screen device may present various control icons thereon for operator assistance.

The display device 212 may provide visual outputs as well as audible outputs. The display device 212 may include an electroluminescent (ELD) display, liquid crystal display (LCD), light-emitting diode (LED) display, a thin-film transistor (TFT), and the like. Further, the display device 212 may include a portable handheld device, such as, a mobile phone, a tablet, and the like. It may also be contemplated that the display device 212 may embody a heads-up display unit, without any limitations.

Further, the collision avoidance system 200 includes a controller 214 communicably coupled with the sensor 202, the imaging device 204, 206, 208, 210, and the display device 212. The controller 214 may be present onboard the work machine 100. In an example, the controller 214 may embody a central control unit associated with the work machine 100 that may be capable of controlling numerous machine functions. Alternatively, the controller 214 may embody an off-board controller. The controller 214 may embody a single microprocessor or multiple microprocessors for receiving various input signals from various components of the work machine 100. Numerous commercially available microprocessors may be configured to perform the functions of the controller 214. The controller 214 may include a central processing unit, a graphics processing unit, and the like. The controller 214 may also include a processing logic, such as, a field-programmable gate array (FPGA), an application-specific integrated circuit (ASIC), and the like.

The controller 214 includes a memory 216. The memory 216 may include a flash memory, a random-access memory (RAM), an electrically erasable programmable read-only memory (EEPROM), and the like. The memory 216 may be used to store data, such as, algorithms, instructions, arithmetic operations, and the like. The controller 214 may execute various types of digitally-stored instructions, such as, a software or an algorithm, retrieved from the memory 216, or a firmware program which may enable the controller 214 to perform a wide variety of operations.

The controller 214 receives the signal “I3” indicative of the presence of the obstacle 142, 302, 402 in the surrounding area 140 of the work machine 100 from the sensor 202. Further, the controller 214 determines a position of the obstacle 142, 302, 402 relative to the work machine 100 based on the signal “I3” received from the sensor 202. The controller 214 may determine the presence of the obstacle 142, 302, 402 proximate to one or more of the front end 104 of the work machine 100, the rear end 106 of the work machine 100, and the one or more sides 108 of the work machine 100. The side 108 of the work machine 100 may include the first side 108 or the side of the work machine 100 may include the second side.

In some examples, the controller 214 may determine the position of the obstacle 142, 302, 402 based on the analysis of the signal “I3” received from the sensor 202. In an example, when the sensor 202 includes the imaging device 204, 206, 208, 210, the controller 214 may determine the position of the obstacle 142, 302, 402 based on the mounting location of the imaging device 204, 206, 208, 210 i.e., a height and an angle at which the imaging device 204, 206, 208, 210 is mounted. Additionally, the controller 214 may analyze the obstacle 142, 302, 402 in a field of the view of the corresponding imaging device 204, 206, 208, 210. Based on the analysis, the controller 214 may determine the distance “D1” between the obstacle 142, 302, 402 and the work machine 100 or the bearing angle of the obstacle 142, 302, 402 from the work machine 100. It should be noted that the parameters i.e., the distance “D1” and the bearing angle mentioned herein are exemplary in nature and the controller 214 may determine the position of the obstacle 142, 302, 402 based on other parameters not mentioned herein, without any limitations. Further, the controller 214 generates a first control signal “O1” to prevent a movement of the work machine 100, halt the movement of the work machine 100, or reduce a velocity of the work machine 100 based on the determination of the position of the obstacle 142, 302, 402. The controller 214 may generate the first control signal “O1” based on one or more of the distance “D1” between the obstacle 142, 302, 402 and the work machine 100 and the bearing angle of the obstacle 142, 302, 402 from the work machine 100.

It should be further noted that the controller 214 may compare the position of the work machine 100 with the direction of movement of the one or more movable components of the work machine 100 for generating the first control signal “O1”. The movable components may include the linkage assembly 122 (see FIG. 1), the work implement 120 (see FIG. 1), the ground engaging members 124 (see FIG. 1), the upper structure 114, etc. For this purpose, the controller 214 may be in communication with the first sensor 132 and the second sensor 134. In some examples, the controller 214 may determine the direction of movement of the work machine 100 itself for generating the first control signal “O1”. In some examples, data received from the first and/or second sensors 132, 134, may assist the controller 214 in determining the direction of movement of the one or more movable components of the work machine 100. For example, when the obstacle 142, 302, 402 may be present at the first side 108 of the work machine 100, and the linkage assembly 122 is swinging towards the first side 108 of the work machine 100, the first and/or second sensors 132, 134, may generate the signals “I1”, “I2” indicating the movement of the linkage assembly 122 towards the first side 108. Based on the signals “I1”, “I2” received from the first and/or second sensors 132, 134, indicating the movement of the linkage assembly 122 towards the first side 108 and the signals “I3” received from the sensor 202 indicating the presence of the obstacle 142, 302, 402 on the first side 108, the controller 214 may generate the first control signal “O1” to prevent the movement, halt the movement, or reduce the velocity of the work machine 100.

In some examples, the controller 214 may generate the first control signal “O1” if the obstacle 142, 302, 402 lies within a predetermined distance value “V1” from the work machine 100. For this purpose, the controller 214 may compare the distance “D1” between the obstacle 142, 302, 402 and the work machine 100 with the predetermined distance value “V1” between the obstacle 142, 302, 402 and the work machine 100 for generating the first control signal “O1”. The predetermined distance value “V1” may be stored within the memory 216 associated with the controller 214 and may be retrieved from the memory 216 as and when required. Further, the controller 214 may generate the first control signal “O1” if the distance “D1” between the obstacle 142, 302, 402 and the work machine 100 is less than the predetermined distance value “V1”.

Further, the controller 214 may generate the first control signal “O1” to halt the movement of the work machine 100 or reduce the velocity of the work machine 100 based on the position of the obstacle 142, 302, 402. For example, if the distance “D1” between the work machine 100 and the obstacle 142, 302, 402 is greater than a predefined value “V2”, the controller 214 may generate the first control signal “O1” to reduce the velocity of the work machine 100. It should be noted that the velocity of the work machine 100 may be determined based on the distance “D1” between the obstacle 142, 302, 402 and the work machine 100 and/or the bearing angle of the obstacle 142, 302, 402 from the work machine 100.

However, if the distance “D1” between the work machine 100 and the obstacle 142, 302, 402 is lesser than the predefined value “V2”, the controller 214 may generate the first control signal “O1” to halt the movement of the work machine 100. The predefined value “V2” between the work machine 100 and the obstacle 142, 302, 402 may be stored within the memory 216 associated with the controller 214 and may be retrieved from the memory 216 as and when required. It should be noted that the predetermined distance value “V1” and the predefined value “V2” may be decided on a variety of factors, such as, a size of the work machine 100, a terrain at the worksite 102, a size of the worksite 102, and the like. In some examples, the machine operator may be able to adjust the predetermined distance value “V1” and the predefined value “V2”, as per application requirements.

Further, in some examples, the controller 214 may determine the position of the obstacle 142, 302, 402 before initiating the movement of the work machine 100, such that the controller 214 generates the first control signal “O1” to prevent the movement of the work machine 100 based on the determination of the position of the obstacle 142, 302, 402. More particularly, in a situation wherein the work machine 100 is about to move in the reverse direction “R” and the controller 214 determines a presence of the obstacle 142 proximate to the rear end 106 of the work machine 100, the controller 214 may generate the first control signal “O1” to prevent the movement of the work machine 100 in the reverse direction “R”. It should be noted that the data corresponding to the movement of the work machine 100 in the reverse direction “R” may be received from the first and/or second sensors 132, 134.

Moreover, in some examples, the controller 214 may determine the position of the obstacle 142, 302, 402 during the movement of the work machine 100, such that the controller 214 generates the first control signal “O1” to halt the movement of the work machine 100 or reduce the velocity of the work machine 100 based on the determination of the position of the obstacle 142, 302, 402. More particularly, in a situation wherein the work machine 100 is moving in the reverse direction “R” and the controller 214 determines a presence of the obstacle 142 proximate to the rear end 106 (see FIG. 1) of the work machine 100, the controller 214 may generate the first control signal “O1” to halt the movement of the work machine 100 or reduce the velocity of the work machine 100 while the work machine 100 is moving in the reverse direction “R”. It should be noted that the data corresponding to the movement of the work machine 100 or the movable components of the work machine 100 may be received from the first and/or second sensors 132, 134.

Further, the first control signal “O1” generated by the controller 214 may be transmitted to the braking system of the work machine 100, the transmission system of the work machine 100, the drivetrain of the work machine 100, or any other component of the work machine 100 that may allow control of the movement of the work machine 100, without any limitations. In some examples, the velocity of the work machine 100 may be controlled based on a control of the ground engaging members 124. In such examples, the first control signal “O1” may be transmitted to components, such as, hydraulic valves or hydraulic motors, that may operate the ground engaging members 124, so that the work machine 100 may move at a desired velocity. In some examples, the controller 214 may generate the first control signal “O1” to control a velocity of the one or more movable components of the work machine 100.

In some examples, the collision avoidance system 200 may allow an operator to override the first control signal “O1” generated by the controller 214. In such examples, the controller 214 may generate a prompt screen on the display device 212. The prompt screen may include an option to continue with a control of the work machine 100 based on the first control signal “O1” generated by the controller 214 or override the first control signal “O1” generated by the controller 214.

If the machine operator chooses to continue with the control of the work machine 100, the controller 214 may control the movement of the work machine 100 based on the generated first control signal “O1”. However, if the machine operator chooses to override the first control signal “O1”, the controller 214 may not intervene with the movements of the work machine 100. It should be noted that the machine operator may choose to override the first control signal “O1” in situations wherein the obstacle 142, 302, 402 is small in size, the machine operator may be able to easily navigate the work machine 100 around the obstacle 142, 302, 402, and the like.

Further, the controller 214 also generates a second control signal “O2” for displaying an updated display view 300, 400 (shown in FIGS. 3 and 4, respectively) based on the determination of the position of the obstacle 142, 302, 402. The updated display view 300, 400 provides a visual indication of the presence of the obstacle 142, 302, 402 in the surrounding area 140 of the work machine 100. In some examples, the updated display view 300, 400 may include images or videos, such that the updated display view 300, 400 may include a portion of the surrounding area 140 of the work machine 100 in which the obstacle 142, 302, 402 is present. In other examples, the updated display view 300, 400 may include one or more occupancy maps illustrating the presence of the obstacles 142, 302, 402 in the surrounding area 120 of the work machine 100. It should be noted that the updated display view 300, 400 may include any other type of graphical representation indicating the presence of the obstacles 142, 302, 402 in the surrounding area 140 of the work machine 100, without any limitations.

Further, the updated display view 300, 400 may be generated on the display device 212. Specifically, the display device 212 of the display device 212 may display the updated display view 300, 400 for notifying the machine operator regarding the presence of the obstacle 142, 302, 402 around the work machine 100. It should be noted that the controller 214 may generate the first and second control signals “O1”, “O2” at the same time. In some examples, the controller 214 may generate the first control signal “O1” before generating the second control signal “O2”. In other examples, the controller 214 may generate the second control signal “O2” before generating the first control signal “O1”.

Further, the controller 214 may determine the one or more imaging devices 204, 206, 208, 210 from the number of imaging devices 204, 206, 208, 210 that capture the visual feed 303, 403, 413 of the obstacle 142, 302, 402. More particularly, based on the position of the obstacle 142, 302, 402, the controller 214 may determine the imaging device 204, 206, 208, 210 that may capture the visuals of the obstacle 142, 302, 402.

Further, the controller 214 may generate the second control signal “O2” to display the updated display view 300, 400, such that the updated display view 300, 400 includes the obstacle 142, 302, 402. For example, when the obstacle 142 is present proximate the rear end 106 of the work machine 100, the controller 214 may generate the second control signal “O2” such that the visuals captured by the imaging device 206 may be displayed on the display device 212.

It should be noted that, in some situations, the obstacle 142, 302, 402 may be positioned at the worksite 102 such that the visuals of the obstacle 142, 302, 402 may be captured by more than one imaging device 204, 206, 208, 210. For example, in a situation wherein the obstacle 142, 302, 402 may include a huge pile of material disposed partially on the first side 108 and partially at the rear end 106, the controller 214 may generate the second control signal “O2” such that the updated display view 300, 400 includes the visuals captured by the imaging devices 206, 208. For example, the updated display view 300, 400 may include a split screen view illustrating two visual feeds of the same pile of material. In such examples, the split screen view may include the two visual feeds arranged one above the other or side-by-side, without any limitations.

It may be further possible that more than one obstacle 142, 302, 402 may be present around the work machine 100 at an instant of time. For example, the obstacle 142, 302, 402 may include a personnel present at the second side of the work machine 100 and another work machine present proximate to the rear end 106 of the work machine 100. In such situations, the controller 214 may generate the second control signal “O2” such that the updated display view 300, 400 includes visuals from the imaging device 210 that captures the obstacle 142, 302, 402 embodied as the personnel as well as the visual feed 303, 403, 413 received from the imaging device 204, 206, 208, 210 that captures the obstacle 142, 302, 402 embodied as the work machine, without any limitations. Further, based on the generation of the second control signal “O2”, the display device 212 may instantly display the updated display view 300, 400 thereon to notify the machine operator regarding the presence of the obstacle 142, 302, 402.

FIG. 3 illustrates the exemplary updated display view 300 illustrating the visual feed 303 including the obstacle 302. The obstacle 302 is embodied as a work machine disposed proximal to the second side of the work machine 100. As shown in FIG. 3, the display device 212 may display the updated display view 300 as a full screen view on the display device 212. It should be noted that the updated display view 300 illustrated herein is exemplary in nature. In addition to the visual feed 303, the updated display view 300 may include other control icons or notification icons for providing alarms, warnings, operating conditions of one or more components of the work machine 100, and the like.

As illustrated in FIG. 3, the display device 212 displays the updated display view 300 illustrating the visual feed 303 from the single imaging device 210 (see FIG. 2). As such, the visual feed 303 may be received from the imaging device 210 mounted at the second side of the work machine 100. In some examples, the display device 212 may also provide audible outputs for notifying the machine operator regarding the presence of the obstacle 302.

Further, in addition to the visual feed 303, the updated display view 300 may also include a first indication system 304. The first indication system 304 may be displayed at any location of the display device 212. The first indication system 304 may include a first indication 306 that provides a visual depiction of a status of the collision avoidance system 200. More particularly, the first indication 306 may notify whether the collision avoidance system 200 is activated, if one or more audible outputs are off, or if there is an error in operation of the collision avoidance system 200. As such, the first indication 306 may indicate diagnosis information of the collision avoidance system 200.

The first indication 306 may include unique features so that the machine operator can easily differentiate between different indications being provided by the first indication 306. The first indication 306 may include different hatchings or different color codes. For example, if the first indication 306 includes a red color, the first indication 306 may depict that there may be an error in operation of the collision avoidance system 200. Further, if the first indication 306 includes a yellow color, the first indication 306 may depict that the audible outputs are off. Moreover, if the first indication 306 includes a white color, the first indication 306 may depict that the collision avoidance system 200 is activated. In the illustrated example, the first indication 306 includes a hatching that depicts that the collision avoidance system 200 is activated.

The first indication system 304 may also include a second indication 308 that may notify the machine operator regarding the imaging device 204, 206, 208, 210 (see FIG. 2) that is generating the visual feed 303. The second indication 308 may include unique features so that the machine operator can easily identify the imaging device 204, 206, 208, 210 that is generating the visual feed 303. The second indication 308 may include different hatchings or different color codes. For example, in the illustrated example of FIG. 3, the second indication 308 includes a hatching notifying that the imaging device 210 is generating the visual feed 303. In other examples, the second indication 308 may include a white color, a yellow color, or a red color notifying that the imaging device 210 is generating the visual feed 303.

The first indication system 304 may further include a third indication 310 that provides a visual depiction of the position of the obstacle 302 relative to the work machine 100. More particularly, the third indication 310 may notify whether the obstacle 302 lies at a first range of distance “D2” (shown in FIG. 2) from the work machine 100, a second range of distance “D3” (shown in FIG. 2) from the work machine 100 that may be lesser than the first range of distance “D2”, or a third range of distance “D4” (shown in FIG. 2) from the work machine 100 that may be lesser than the first and second range of distances “D2”, “D3”. The first, second, and third range of distances “D2”, “D3”, “D4” may be prestored in the memory 216 (see FIG. 2).

The third indication 310 may include unique features so that the machine operator can easily differentiate between different indications being provided by the third indication 310. The third indication 310 may include different hatchings or different color codes. For example, if the third indication 310 includes a red color, the first indication 306 may depict that the obstacle 302 lies within the first range of distance “D2” from the work machine 100. Further, if the third indication 310 includes a yellow color, the third indication 310 may depict that the obstacle 302 lies within the second range of distance “D3” from the work machine 100. Moreover, if the third indication 310 includes a white color, the third indication 310 may depict that the obstacle 302 lies within the third range of distance “D4” from the work machine 100. In the illustrated example, the third indication 310 includes a hatching that depicts that the obstacle 302 lies within the third range of distance “D4” from the work machine 100.

It should be noted that the first indication system 304 does not display indications for the front end 104 (see FIG. 1) of the work machine 100 herein as the work machine 100 may move in the reverse direction “R” (see FIG. 1). However, in other examples, wherein the work machine is moving in the forward direction “F” (see FIG. 1), the first indication system 304 may also display indications for the front end 104 of the work machine 100.

Referring now to FIG. 4, the updated display view 400 illustrates the visual feed 403, 413 including the obstacles 402, 142, respectively. The updated display view 400 may display the visual feeds 403, 413 from the imaging devices 206, 208 (see FIG. 2) thereon. In the illustrated example of FIG. 4, the visual feed 403 is displayed vertically above the visual feed 413. However, in other examples, the visual feeds 403, 413 may be displayed adjacent to each other. Moreover, in examples wherein an additional obstacle (not shown) is present proximate the second side of the work machine 100, a third visual feed from the imaging device 210 (see FIG. 2) may be depicted on the display device 212, without any limitations. Accordingly, in various examples, the updated display view 400 may include visuals received from all of the imaging devices 204, 206, 208, 210 (see FIG. 2), without any limitations. It should be noted that the updated display view 400 illustrated herein is exemplary in nature. In addition to the visual feed 403, 413, the updated display view 400 may include other control icons or notification icons for providing alarms, warnings, operating conditions of one or more components of the work machine 100, and the like.

As illustrated in FIG. 4, the updated display view 400 illustrates the visual feed 403 including the obstacle 402. The obstacle 402 is embodied as a personnel present proximal to the first side 108 (see FIG. 2) of the work machine 100. It should be noted that the visual feed 403 may be received from the imaging device 208 mounted proximate to the first side 108 of the work machine 100. In some examples, the display device 212 may also provide audible outputs for notifying the machine operator regarding the presence of the obstacle 402.

Further, in addition to the visual feed 403, the updated display view 400 may also include a second indication system 404 similar to the first indication system 304 explained in relation to FIG. 4. The second indication system 404 may be displayed at any location of the display device 212. The second indication system 404 may include a first indication 406 that provides the visual depiction of the status of the collision avoidance system 200. In the illustrated example, the first indication 406 includes a hatching that depicts that the collision avoidance system 200 is activated. The second indication system 404 may also include a second indication 408 that may notify the machine operator regarding the imaging device 204, 206, 208, 210 that is generating the visual feed 403. For example, in the illustrated example of FIG. 4, the second indication 408 includes a hatching notifying the machine operator that the imaging device 208 is generating the visual feed 403.

The second indication system 404 may also include a third indication 410 that provides a visual depiction of the position of the obstacle 402 relative to the work machine 100. More particularly, the third indication 410 may notify whether the obstacle 402 lies within the first range of distance “D2” (see FIG. 2) from the work machine 100, the second range of distance “D3” (see FIG. 2) from the work machine 100, or the third range of distance “D4” (see FIG. 2) from the work machine 100. In the illustrated example, the third indication 410 includes a hatching that depicts that the obstacle 402 lies within the first range of distance “D2” from the work machine 100.

It should be noted that the second indication system 404 does not display indications for the front end 104 (see FIG. 1) of the work machine 100 herein as the work machine 100 may move in the reverse direction “R” (see FIG. 1). However, in other examples, wherein the work machine is moving in the forward direction “F” (see FIG. 1), the second indication system 404 may also display indications for the front end 104 of the work machine 100.

Further, the updated display view 400 illustrates the visual feed 413 including the obstacle 142. The obstacle 142 is embodied as a fire hydrant present proximal to the rear end 106 of the work machine 100. It should be noted that the visual feed 413 may be received from the imaging device 206 mounted proximate to the rear end 106 of the work machine 100. In some examples, the display device 212 may also provide audible outputs for notifying the machine operator regarding the presence of the obstacle 142.

Further, in addition to the visual feed 413, the updated display view 400 may include a third indication system 414 similar to the first indication system 304 explained in relation to FIG. 3. The third indication system 414 may be displayed at any location of the display device 212. The third indication system 414 may include a first indication 416 that provides the visual depiction of the status of the collision avoidance system 200. In the illustrated example, the first indication 416 includes a hatching that depicts that the collision avoidance system 200 is activated.

The third indication system 414 may also include a second indication 418 that may notify the machine operator regarding the imaging device 204, 206, 208, 210 that is generating the visual feed 413. More particularly, in the illustrated example of FIG. 4, the second indication 418 may notify the machine operator that the imaging device 206 is generating the visual feed 413. In the illustrated example of FIG. 4, the second indication 418 includes a hatching notifying that the imaging device 206 is generating the visual feed 413. The third indication system 414 may also include a third indication 420 that provides a visual depiction of the position of the obstacle 142 relative to the work machine 100. More particularly, the third indication 420 may notify whether the obstacle 142 lies within the first range of distance “D2” from the work machine 100, the second range of distance “D3” from the work machine 100, or the third range of distance “D4” from the work machine 100. In the illustrated example, the first indication 416 includes a hatching that depicts that the obstacle 142 lies within the first range of distance “D2” from the work machine 100.

It should be noted that the third indication system 414 does not display indications for the front end 104 of the work machine 100 herein as the work machine 100 may move in the reverse direction “R”. However, in other examples, wherein the work machine is moving in the forward direction “F”, the third indication system 414 may also display indications for the front end 104 of the work machine 100.

### INDUSTRIAL APPLICABILITY

The present disclosure relates to the collision avoidance system 200 and a method 500 for avoiding collision of the work machine 100 with the one or more obstacles 142, 302, 402. The collision avoidance system 200 may collect real time and accurate information regarding the presence of one or more obstacles 142, 302, 402 around the work machine 100 and accordingly control the movements of the work machine 100 to eliminate any possibility of collision between the obstacles 142, 302, 402 and the work machine 100. Thus, the collision avoidance system 200 may provide 360 Degrees viewability around the work machine 100.

Further, in an example, the collision avoidance system 200 may allow the machine operator to override the first control signal “O1” generated by the controller 214, as per requirements. In some examples, the machine operator may take a decision to override the first control signal “O1” generated by the controller 214 based on assistance provided by the updated display views 300, 400 on the display device 212. Further, the updated display views 300, 400 may provide real time visuals of the surrounding area 140 of the work machine 100 to the machine operator. Moreover, the indication systems 304, 404, 414 generated on the display device 212 may provide a simplified indication of the determinations made by the collision avoidance system 200 and may also notify the machine operator if there is an error in the operation of the collision avoidance system 200.

The collision avoidance system 200 may increase operational safety of the work machine 100 by providing a means to monitor the surrounding area 140 of the work machine 100 and may also take appropriate actions based on detection of the one or more obstacles 142, 302, 402. The collision avoidance system 200 may be simple in operation and cost effective. Further, the collision avoidance system 200 may be easily retrofitted on existing work machines, without modifying hardware associated with existing work machines. The collision avoidance system 200 may be used with autonomous, semi-autonomous, or manual machines, without any limitations. Further, the collision avoidance system 200 may embody an inclusive and onboard machine system as the collision avoidance system 200 may not require additional inputs from other work machines or other sensors present at the worksite 102.

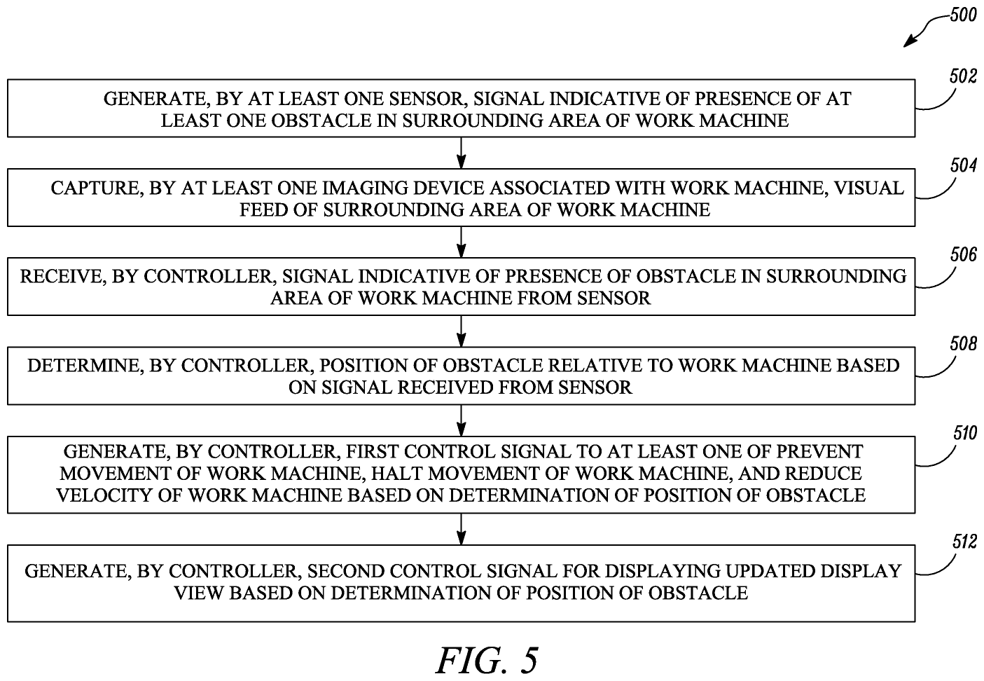

FIG. 5 illustrates a flowchart for the method 500 for avoiding collision of the work machine 100 with the one or more obstacles 142, 302, 402. At step 502, the one or more sensors 202 generate the signal “I3” indicative of the presence of the one or more obstacles 142, 302, 402 in the surrounding area 140 of the work machine 100. At step 504, the one or more imaging devices 204, 206, 208, 210 associated with the work machine 100 captures the visual feed 303, 403, 413 of the surrounding area 140 of the work machine 100. In some examples, the method 500 includes a step of capturing the visual feed 303, 403, 413 of the surrounding area 140 of the work machine 100 by the number of imaging devices 204, 206, 208, 210.

At step 506, the controller 214 receives the signal “I3” indicative of the presence of the obstacle 142, 302, 402 in the surrounding area 140 of the work machine 100 from the sensor 202. The controller 214 is communicably coupled to the sensor 202, the imaging device 204, 206, 208, 210, and the display device 212 associated with the work machine 100. At step 508, the controller 214 determines the position of the obstacle 142, 302, 402 relative to the work machine 100 based on the signal “I3” received from the sensor 202. Further, the controller 214 determines the presence of the obstacle 142, 302, 402 proximate to one or more of the front end 104 of the work machine 100, the rear end 106 of the work machine 100, and the one or more sides 108 of the work machine 100.

At step 510, the controller 214 generates the first control signal “O1” to prevent the movement of the work machine 100, halt the movement of the work machine 100, or reduce the velocity of the work machine 100 based on the determination of the position of the obstacle 142, 302, 402. Further, the controller 214 may determine one or more of the distance “D1” between the obstacle 142, 302, 402 and the work machine 100 and the bearing angle of the obstacle 142, 302, 402 from the work machine 100 for generating the first control signal “O1”. Moreover, the controller 214 may compare the position of the work machine 100 with the direction of movement of the one or more movable components of the work machine 100 for generating the first control signal “O1”.

At step 512, the controller 214 generates the second control signal “O2” for displaying the updated display view 300, 400 based on the determination of the position of the obstacle 142, 302, 402. The updated display view 300, 400 provides a visual indication of the presence of the obstacle 142, 302, 402 in the surrounding area 140 of the work machine 100. Further, the display device 212 displays the updated display view 300, 400 as the full screen view on the display device 212. In some examples, the controller 214 may determine the one or more imaging devices 204, 206, 208, 210 from the number of imaging devices 204, 206, 208, 210 that capture the visual feed 303, 403, 413 of the obstacle 142, 302, 402. Further, the controller 214 may generate the second control signal “O2” to display the updated display view 300, 400, such that the updated display view 300, 400 includes the obstacle 142, 302, 402.

It may be desirable to perform one or more of the steps shown in FIG. 5 in an order different from that depicted. Furthermore, various steps could be performed together.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof.

1. A collision avoidance system for a work machine, the collision avoidance system comprising:
at least one sensor configured to generate a signal indicative of a presence of at least one obstacle in a surrounding area of the work machine;
at least one imaging device associated with the work machine, the imaging device being configured to capture a visual feed of the surrounding area of the work machine;
a display device associated with the work machine; and
a controller communicably coupled with the sensor, the imaging device, and the display device, wherein the controller is configured to:
receive the signal indicative of the presence of the obstacle in the surrounding area of the work machine from the sensor;
determine a position of the obstacle relative to the work machine based on the signal received from the sensor;
generate a first control signal to at least one of prevent a movement of the work machine, halt the movement of the work machine, and reduce a velocity of the work machine based on the determination of the position of the obstacle; and
generate a second control signal for displaying an updated display view based on the determination of the position of the obstacle, wherein the updated display view provides a visual indication of the presence of the obstacle in the surrounding area of the work machine.

2. The collision avoidance system of claim 1, wherein the display device is configured to display the updated display view as a full screen view on the display device.

3. The collision avoidance system of claim 1, wherein the controller is further configured to determine the presence of the obstacle proximate to at least one of a front end of the work machine, a rear end of the work machine, and one or more sides of the work machine.

4. The collision avoidance system of claim 1, wherein the at least one imaging device includes a plurality of imaging devices that capture the visual feed of the surrounding area of the work machine, and wherein the controller is further configured to:
determine one or more imaging devices from the plurality of imaging devices that capture the visual feed of the obstacle; and
generate the second control signal to display the updated display view, such that the updated display view includes the obstacle.

5. The collision avoidance system of claim 1, wherein the controller is further configured to determine at least one of a distance between the obstacle and the work machine and a bearing angle of the obstacle from the work machine for generating the first control signal.

6. The collision avoidance system of claim 1, wherein the controller is further configured to compare the position of the work machine with a direction of movement of one or more movable components of the work machine for generating the first control signal.

7. The collision avoidance system of claim 1, wherein the controller is further configured to:
determine the position of the obstacle before initiating the movement of the work machine, such that the controller generates the first control signal to prevent the movement of the work machine based on the determination of the position of the obstacle; and
determine the position of the obstacle during the movement of the work machine, such that the controller generates the first control signal to at least one of halt the movement of the work machine and reduce the velocity of the work machine based on the determination of the position of the obstacle; and
generate the first control signal if the obstacle lies within a predetermined distance value from the work machine.

8. A method for avoiding collision of a work machine with at least one obstacle, the method comprising:
generating, by at least one sensor, a signal indicative of a presence of the at least one obstacle in a surrounding area of the work machine;
capturing, by at least one imaging device associated with the work machine, a visual feed of the surrounding area of the work machine;
receiving, by a controller, the signal indicative of the presence of the obstacle in the surrounding area of the work machine from the sensor, wherein the controller is communicably coupled to the sensor, the imaging device, and a display device associated with the work machine;
determining, by the controller, a position of the obstacle relative to the work machine based on the signal received from the sensor;
generating, by the controller, a first control signal to at least one of prevent a movement of the work machine, halt the movement of the work machine, and reduce a velocity of the work machine based on the determination of the position of the obstacle; and
generating, by the controller, a second control signal for displaying an updated display view based on the determination of the position of the obstacle, wherein the updated display view provides a visual indication of the presence of the obstacle in the surrounding area of the work machine.

9. The method of claim 8 further comprising displaying, by the display device, the updated display view as a full screen view on the display device.

10. The method of claim 8 further comprising determining, by the controller, the presence of the obstacle proximate to at least one of a front end of the work machine, a rear end of the work machine, and one or more sides of the work machine.

11. The method of claim 8 further comprising capturing, by a plurality of imaging devices, the visual feed of the surrounding area of the work machine.

12. The method of claim 11, further comprising:
determining, by the controller, one or more imaging devices from the plurality of imaging devices that capture the visual feed of the obstacle; and
generating, by the controller, the second control signal to display the updated display view, such that the updated display view includes the obstacle.

13. The method of claim 8 further comprising determining, by the controller, at least one of a distance between the obstacle and the work machine and a bearing angle of the obstacle from the work machine for generating the first control signal.

14. The method of claim 8 further comprising comparing, by the controller, the position of the work machine with a direction of movement of one or more movable components of the work machine for generating the first control signal.

15. A work machine comprising:
a frame;
a plurality of ground engaging members supported by the frame; and
a collision avoidance system comprising:
at least one sensor configured to generate a signal indicative of a presence of at least one obstacle in a surrounding area of the work machine;
at least one imaging device associated with the work machine, the imaging device being configured to capture a visual feed of the surrounding area of the work machine;
a display device associated with the work machine; and
a controller communicably coupled with the sensor, the imaging device, and the display device, wherein the controller is configured to:
receive the signal indicative of the presence of the obstacle in the surrounding area of the work machine from the sensor;
determine a position of the obstacle relative to the work machine based on the signal received from the sensor;
generate a first control signal to at least one of prevent a movement of the work machine, halt the movement of the work machine, and reduce a velocity of the work machine based on the determination of the position of the obstacle; and
generate a second control signal for displaying an updated display view based on the determination of the position of the obstacle, wherein the updated display view provides a visual indication of the presence of the obstacle in the surrounding area of the work machine.

16. The work machine of claim 15, wherein the display device is configured to display the updated display view as a full screen view on the display device.

17. The work machine of claim 15, wherein the controller is further configured to determine the presence of the obstacle proximate to at least one of a front end of the work machine, a rear end of the work machine, and one or more sides of the work machine.

18. The work machine of claim 15, wherein the at least one imaging device includes a plurality of imaging devices that capture the visual feed of the surrounding area of the work machine, and wherein the controller is further configured to:
determine one or more imaging devices from the plurality of imaging devices that capture the visual feed of the obstacle; and
generate the second control signal to display the updated display view, such that the updated display view includes the obstacle.

19. The work machine of claim 15, wherein the controller is further configured to determine at least one of a distance between the obstacle and the work machine and a bearing angle of the obstacle from the work machine for generating the first control signal.

20. The work machine of claim 15, wherein the controller is further configured to compare the position of the work machine with a direction of movement of one or more movable components of the work machine for generating the first control signal.
